(19) United States
(12) Patent Application Publication
(10) Pub. No.: US 2026/0005821 A1
(43) Pub. Date: Jan. 1, 2026

(54) MESSAGE ADAPTATION OVER NONCOHERENT CHANNELS

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Greentown, PA (US)

(21) Appl. No.: 18/755,335

(22) Filed: Jun. 26, 2024

(51) Int. Cl. H04L 5/00; H04W 72/02

(52) U.S. Cl. CPC H04L 5/0094; H04W 72/02

(57) ABSTRACT

Methods, systems, and devices for wireless communications are described. In low signal to noise ratio (SNR) conditions, a transmitting wireless communication device may use non-coherent transmissions, which may be transmissions without corresponding pilot sequences. Non-coherent transmissions may involve transmissions in subsets of symbols based on a duty cycle to increase the peak transmission power of the message in the transmitted symbols. A transmitting wireless communication device may select at least one of the duty cycle, the bandwidth, or the quantity of bits included in a non-coherent message (e.g., the message length) to satisfy a performance demand for the message. For example, the message length may be adjusted by increasing or decreasing the amount of redundancy or by adjusting code block groups. As another example, selecting a larger bandwidth may allow for transmission via more frequency resources, and accordingly, selection of a larger bandwidth may allow for a larger message size.

### FIELD OF TECHNOLOGY

The following relates to wireless communications, including message adaptation over noncoherent channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first wireless communication device is described. The method may include selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message and transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

A first wireless communication device for wireless communications is described. The first wireless communication device may include one or more memories storing processor executable code, and one or more processors coupled with the one or more memories. The one or more processors may individually or collectively be operable to execute the code to cause the first wireless communication device to select, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message and transmit, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

Another first wireless communication device for wireless communications is described. The first wireless communication device may include means for selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message and means for transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

A non-transitory computer-readable medium storing code for wireless communications is described. The code may include instructions executable by one or more processors to select, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message and transmit, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

Some examples of the method, first wireless communication devices, and non-transitory computer-readable medium described herein may further include operations, features, means, or instructions for identifying a set of data bits for transmission to the second wireless communication device, where the at least one of the bandwidth, the duty cycle, or the quantity of bits may be selected to transmit the set of data bits within a single symbol based on the one or more performance demands.

Some examples of the method, first wireless communication devices, and non-transitory computer-readable medium described herein may further include operations, features, means, or instructions for identifying a set of data bits for transmission to the second wireless communication device, where the quantity of bits in the message may be selected based on the one or more performance demands associated with the message, and where selecting the quantity of bits includes selecting an amount of redundancy to include in the message for the quantity of bits.

Some examples of the method, first wireless communication devices, and non-transitory computer-readable medium described herein may further include operations, features, means, or instructions for identifying a set of data bits for transmission to the second wireless communication device, where the quantity of bits in the message may be selected based on the one or more performance demands associated with the message, and where selecting the quantity of bits includes selecting a subset of the set of data bits to include in the transmission.

Some examples of the method, first wireless communication devices, and non-transitory computer-readable medium described herein may further include operations, features, means, or instructions for transmitting, to the second wireless communication device and subsequent to transmission of the message, a second message including a second subset of the set of data bits.

Some examples of the method, first wireless communication devices, and non-transitory computer-readable medium described herein may further include operations, features, means, or instructions for selecting a smaller duty cycle from a range of selectable duty cycles to satisfy an error performance demand, where the duty cycle may be selected based on the one or more performance demands, and where the one or more performance demands include the error performance demand.

Some examples of the method, first wireless communication devices, and non-transitory computer-readable medium described herein may further include operations, features, means, or instructions for selecting a larger duty cycle from a range of selectable duty cycles to satisfy a delay demand, where the duty cycle may be selected based on the one or more performance demands, and where the one or more performance demands include the delay demand.

In some examples of the method, first wireless communication devices, and non-transitory computer-readable medium described herein, selecting the duty cycle, the bandwidth, and the quantity may include operations, features, means, or instructions for selecting a larger bandwidth from within a range of selectable bandwidths to satisfy an error performance demand or a delay demand, where the bandwidth may be selected based on the one or more performance demands, and where the one or more performance demands include the error performance demand or the delay demand.

Some examples of the method, first wireless communication devices, and non-transitory computer-readable medium described herein may further include operations, features, means, or instructions for selecting, for a second message subsequent to the message, a second duty cycle, a second bandwidth, and a second quantity of bits to include in the second message, where at least one of the second bandwidth, the second duty cycle, or the second quantity of bits may be selected based on one or more second performance demands associated with the second message and based on an absence of a pilot sequence associated with transmission of the second message, and where at least one of the second duty cycle may be different than the duty cycle, the second bandwidth may be different than the bandwidth, or the second quantity of bits may be different than the quantity of bits and transmitting, to the second wireless communication device or a third wireless communication device, the second message including the second quantity of bits during one or more second symbols of a second set of multiple symbols and via one or more second frequency resources within the second bandwidth, where the first wireless communication device refrains from transmission during a second remainder of the second set of multiple symbols, where the second duty cycle corresponds to a ratio of the one or more second symbols to a second total quantity of symbols of the second set of multiple symbols, the second total quantity of symbols including the one or more second symbols and the second remainder of the symbols.

Some examples of the method, first wireless communication devices, and non-transitory computer-readable medium described herein may further include operations, features, means, or instructions for receiving a feedback from the second wireless communication device for the message, where the at least one of the second bandwidth, the second duty cycle, or the second quantity of bits may be selected based on the feedback.

In some examples of the method, first wireless communication devices, and non-transitory computer-readable medium described herein, transmitting the message may include operations, features, means, or instructions for transmitting the message to a user equipment (UE), where the second wireless communication device may be the UE, and where the first wireless communication device may be a network entity.

In some examples of the method, first wireless communication devices, and non-transitory computer-readable medium described herein, transmitting the message may include operations, features, means, or instructions for transmitting the message to a network entity, where the second wireless communication device may be the network entity, and where the first wireless communication device may be a UE.

Some examples of the method, first wireless communication devices, and non-transitory computer-readable medium described herein may further include operations, features, means, or instructions for transmitting the message to a first UE, where the second wireless communication device may be the first UE, and where the first wireless communication device may be a second UE.

Some examples of the method, first wireless communication devices, and non-transitory computer-readable medium described herein may further include operations, features, means, or instructions for transmitting the message to an energy harvesting (EH)-capable device and receiving, from the EH-capable device, a backscatter response to the message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports message adaptation over noncoherent channels in accordance with one or more aspects of the present disclosure.

FIG. 2 shows an example of a wireless communications system that supports message adaptation over noncoherent channels in accordance with one or more aspects of the present disclosure.

FIG. 3 shows an example of graphs that supports message adaptation over noncoherent channels in accordance with one or more aspects of the present disclosure.

FIG. 4 shows an example of a message length adaptation scheme that supports message adaptation over noncoherent channels in accordance with one or more aspects of the present disclosure.

FIG. 5 shows an example of a bandwidth adaptation scheme that supports message adaptation over noncoherent channels in accordance with one or more aspects of the present disclosure.

FIG. 6 shows an example of a bandwidth adaptation scheme that supports message adaptation over noncoherent channels in accordance with one or more aspects of the present disclosure.

FIG. 7 shows an example of a process flow that supports message adaptation over noncoherent channels in accordance with one or more aspects of the present disclosure.

FIGS. 8 and 9 show block diagrams of devices that support message adaptation over noncoherent channels in accordance with one or more aspects of the present disclosure.

FIG. 10 shows a block diagram of a communications manager that supports message adaptation over noncoherent channels in accordance with one or more aspects of the present disclosure.

FIG. 11 shows a diagram of a system including a UE that supports message adaptation over noncoherent channels in accordance with one or more aspects of the present disclosure.

FIG. 12 shows a diagram of a system including a network entity that supports message adaptation over noncoherent channels in accordance with one or more aspects of the present disclosure.

FIG. 13 shows a flowchart illustrating methods that support message adaptation over noncoherent channels in accordance with one or more aspects of the present disclosure.

### DETAILED DESCRIPTION

In wireless communications systems, some communications channels may experience low signal to noise ratio (SNR) conditions, such as in low transmit power, high pathloss, or wideband scenarios. In low SNR conditions, acquisition of channel state information (CSI) at the receiving device may be unreliable or may not be possible. Non-coherent transmissions may be used in such low SNR conditions. A non-coherent transmission may refer to a transmission without CSI acquisition at the receiving device. For example, a non-coherent transmission may refer to a transmission without a corresponding pilot sequence (e.g., without a demodulation reference signal (DMRS) accompanying the transmission). Non-coherent transmissions may involve transmissions in subsets of available symbols in accordance with a transmission duty cycle, which may enable the transmitting device to increase the (peak) transmission power of the message in the symbols in which transmission occurs. In addition, the transmission may also concentrate this power in a small fraction of the available transmission bandwidth. Such transmissions that concentrate power in time (through duty-cycled transmission) and frequency (by occupying only a fraction of bandwidth) may be referred to as peaky transmissions, which may equivalently refer to as using higher transmission power in a subsets of available symbols. Peaky transmissions may be used in low SNR conditions due to the higher peak transmission power used in the symbols in which transmission does occur, thereby leading to higher SNR per occupied bandwidth. As the duty cycle increases (for example, becomes closer to 1), the error performance deteriorates, as the peak transmission power in the occupied bandwidth may not be enough to yield sufficient SNR per occupied bandwidth in any one symbol. As the duty cycle decreases (for example, becomes closer to 0), however, the latency may increase, and less data may be transmitted. Further, as the quantity of symbols for a given message increases (e.g., more duty cycle periods are involved in transmission of a same message), the error performance the overall message may deteriorate, as there is an additional opportunity for error in each additional symbol that is used to represent the overall message.

Aspects of this disclosure relate to selection of at least one of the duty cycle, the bandwidth, or the quantity of bits included in a non-coherent message using peaky transmission (e.g., the message length) in order to satisfy a performance demand for the message (e.g., a delay requirement or a latency requirement). For example, the message length may be adjusted by increasing or decreasing the amount of redundancy (e.g., the amount of redundant bits for error checking purposes) in order to meet a latency demand or an error demand. As another example, the transmitting wireless communication device may adjust code block groups (CBGs) (e.g., the transmitting wireless communication device may transmit some data in a subsequent packet) in order to fit a selected message length. As another example, selecting a larger bandwidth may allow for transmission via more frequency resources, and accordingly, selection of a larger bandwidth may allow for a larger message size while complying with a given error and/or latency demand. As another example, the duty cycle may be selected for a message based on the error and/or latency demands (e.g., increased duty cycle to meet a latency demand versus decreased duty cycle to meet an error demand). In some examples, the transmitting wireless communication device may adjust the duty cycle, the bandwidth, or the message length for each message based on the performance demands associated with each message. In some examples, the transmitting wireless communication device may adjust the duty cycle, the bandwidth, or the message length based on feedback from the receiving device in order to ensure compliance with the performance demands.

Aspects of the disclosure are initially described in the context of wireless communications systems. Aspects of the disclosure are further illustrated by and described with reference to graphs, message length adaptation schemes, bandwidth adaptation schemes, process flows, apparatus diagrams, system diagrams, and flowcharts that relate to message adaptation over noncoherent channels.

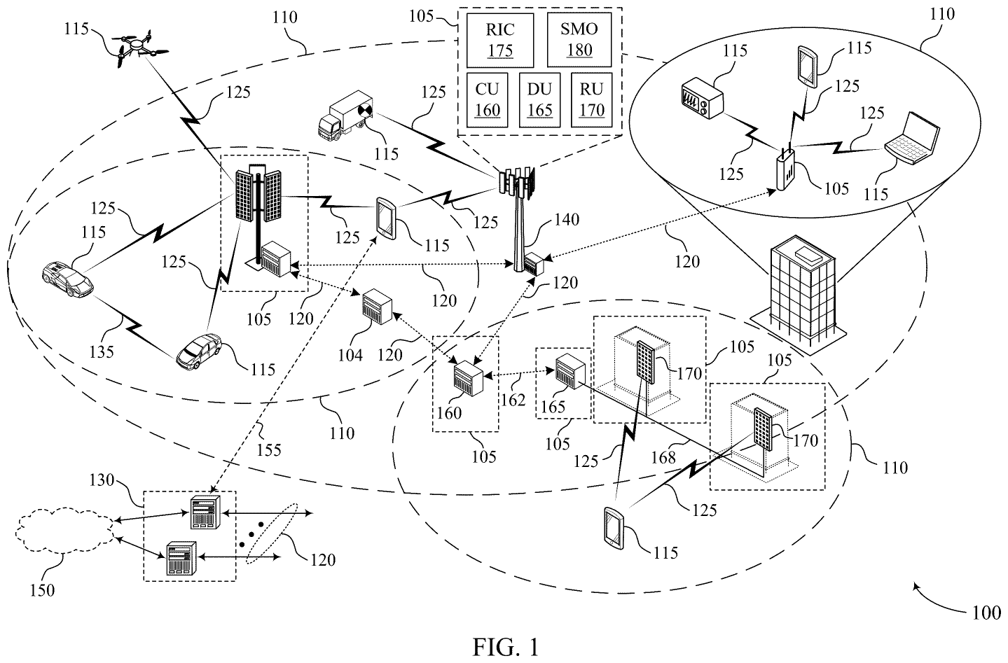

FIG. 1 shows an example of a wireless communications system 100 that supports message adaptation over noncoherent channels in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting wireless device or a receiving device (e.g., a network entity 105, a UE 115) to shape or steer an antenna beam (e.g., a transmit beam, a receive beam) along a spatial path between the transmitting wireless device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting wireless device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting wireless device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting wireless communication device, such as a network entity 105, or by a receiving device, such as a UE 115) a beam direction for later transmission or reception by the network entity 105.

Some signals, such as data signals associated with a particular receiving device, may be transmitted by a transmitting wireless communication device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting wireless communication device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest SNR, or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the communication channel between wireless communication devices (e.g., UEs 115, network entities 105, or energy harvesting (EH)-capable devices such as ambient IoT devices or radio frequency identification (RFID) tags) of the wireless communications system 100 may experience low SNR conditions, such as in low transmit power, high pathloss, or wideband scenarios. Non-coherent peaky transmissions may be used in such low SNR conditions. In some examples, a transmitting wireless communication device may select at least one of the duty cycle, the bandwidth, or the quantity of bits included in a non-coherent message (e.g., the message length) in order to satisfy a performance demand for the message (e.g., a delay requirement or a latency requirement). For example, the message length may be adjusted by increasing or decreasing the amount of redundancy (e.g., the amount of redundant bits for error checking purposes) in order to meet a latency demand or an error demand. As another example, the transmitting wireless communication device may adjust CBGs (e.g., the transmitting wireless communication device may transmit some data in a subsequent packet) in order to fit a selected message length. As another example, selecting a larger bandwidth may allow for transmission via more frequency resources, and accordingly, selection of a larger bandwidth may allow for a larger message size while complying with a given error and/or latency demand. As another example, the duty cycle may be selected for a message based on the error and/or latency demands (e.g., increased duty cycle to meet a latency demand versus decreased duty cycle to meet an error demand). In some examples, the transmitting wireless communication device may adjust the duty cycle, the bandwidth, or the message length for each message based on the performance demands associated with each message. In some examples, the transmitting wireless communication device may adjust the duty cycle, the bandwidth, or the message length based on feedback from the receiving wireless communication device in order to ensure compliance with the performance demands.

As low SNR is a challenge for low-cost energy-constrained devices, such as IoT devices, and non-coherent peaky transmissions may be used because peaky transmissions involve reduced signaling overhead, improved energy efficiency, and the capability to connect massive intelligent devices to cellular ecosystems (e.g., AIoT devices), the disclosed techniques may enable more reliable peaky transmissions (e.g., non-coherent transmissions) for low-cost energy-constrained devices and low SNR conditions.

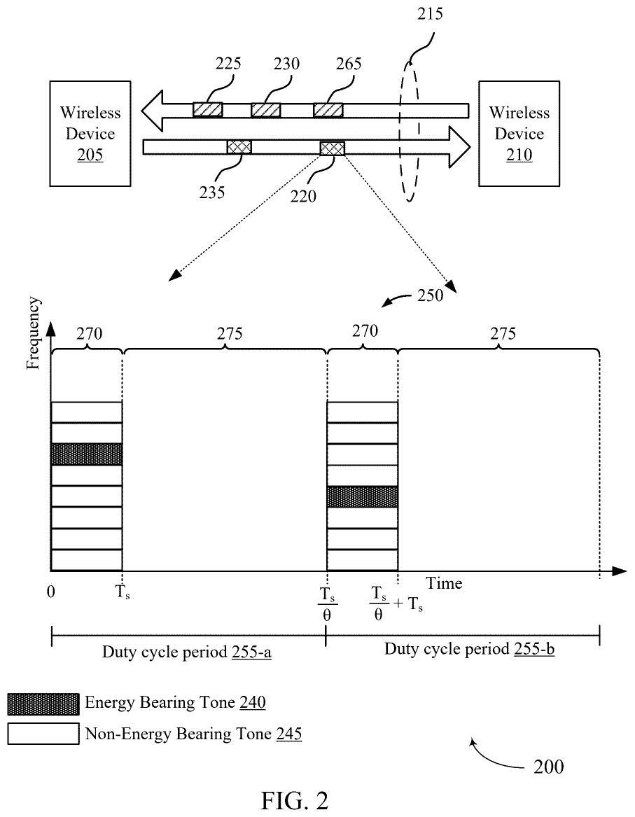

FIG. 2 shows an example of a wireless communications system 200 that supports message adaptation over noncoherent channels in accordance with one or more aspects of the present disclosure. The wireless communications system 200 may implement or may be implemented by aspects of the wireless communications system 100.

The wireless communications system 200 includes a wireless communication device 205 and a wireless communication device 210. The wireless communication device 205 may communicate with the wireless communication device 210 via a communication link 215. In some examples, the communication link 215 may be an example of an NR or LTE link between the wireless communication device 205 and the wireless communication device 210. The communication link 215 may include a bi-directional link that enables the wireless communication device 205 to transmit to the wireless communication device 210 and the wireless communication device 210 to transmit to the wireless communication device 205. In an uplink scenario, the wireless communication device 205 may be a UE 115 as described herein, the wireless communication device 210 may be a network entity 105 as described herein, and the communication link 215 may be an example of a communication link 125 as described herein. In a downlink scenario, the wireless communication device 210 may be a UE 115 as described herein, the wireless communication device 205 may be a network entity 105 as described herein, and the communication link 215 may be an example of a communication link 125 as described herein. In a sidelink scenario, the wireless communication device 205 and the wireless communication device 210 may both be UEs 115 as described herein, and the communication link 15 may be an example of a D2D communication link 135 as described herein. In some examples, the wireless communication device 205 may be a reader device (e.g., an interrogating device) and the wireless communication device 210 may be an EH-capable device (e.g., such as an AIoT device or RFID tag).

In some examples, the communication link 125 may have low SNR conditions, for example, in low transmit power, high pathloss, or wideband scenarios, where received energy per spectrum unit (e.g., Hz) at the receiving device (e.g., the wireless communication device 210 for a transmission by the wireless communication device 205) may be low under fixed transmission power. In scenarios where reliable determination of CSI (e.g., to a precision sufficient for coherent detection) is infeasible, non-coherent peaky transmission without CSI acquisition at the receiver may be used. As described herein, a non-coherent transmission may refer to a transmission without a corresponding (e.g., accompanying) pilot signal. For example, non-coherent transmissions may not demand tracking the carrier phase (e.g., no CSI estimation at the receiving device) and thus no pilot sequence may be transmitted along with a non-coherent transmission, which may lead to better time and/or frequence resource utilization (as a result of using a fraction of allocated bandwidth and time, and by not transmitting any pilot).

Peaky transmissions, such as a message 220 may use multiple peaky symbols scheduled with a duty cycle θ where the transmitting device refrains from transmitting in some symbols of the duty cycle period. Peaky transmission may refer to a non-coherent transmission in accordance with a duty cycle (e.g., transmission may occur only a fraction of the available transmission time). For example, as shown in the resource diagram 250, the wireless communication device 205 may transmit the message 220 in symbols 270 in accordance with a duty cycle 0, and may refrain from transmitting in the other symbols 275 within a given duty cycle period 255. In a peaky transmission, the transmitting device may increase the peak transmit power (e.g., in proportion to the inverse of the duty cycle thereby maintaining a same average transmission power across the symbols within the duty cycle period). Thus, in a peaky transmission, transmission power may be concentrated over time and frequency (e.g., via selecting one or more tones for each transmission). For example, within the symbol 270, the wireless communication device 205 may transmit on one or more available tones (e.g., energy bearing tones 240) and may refrain from transmitting one on ore more other available tones (e.g., non-energy bearing tones 245) within an available bandwidth. For a duty cycle θ, each peaky transmission pulse may be transmitted such that θ<1 and a peak power of P_{avg}/θ, where P_{avg} is the average transmission power. Thus, Pₚₑₐₖ (applied to the symbols and tones on which data is transmitted)=P_{avg}/θ>P_{avg}.

For example, as shown in the resource diagram 250, in the first duty cycle period 255-a, the wireless communication device may transmit the message 220 (or a portion of the message 220) in one or more energy bearing tones 240 (e.g., subcarriers) of the first symbol 270 (e.g., the time from t=0 to Tₛ) and the wireless communication device 205 may refrain from transmitting during the remainder of the first duty cycle period 255-a and in the non-energy bearing tones 245 of the first symbol 270. The duration of the duty cycle period 255 (e.g., each of the first duty cycle period 255-a and the subsequent duty cycle period 255-b) may be equal to Tₛ/θ. If the data of the message 220 does not fit into a single symbol 270, the wireless communication device may continue transmission of the message in a symbol 270 in the subsequent duty cycle period 255-b. The error performance of a message transmitted using peaky transmissions may deteriorate as the quantity of peaky symbols forming the complete message increases.

As described herein, the wireless communication device 205 may select at least one of the duty cycle θ, the message length, or bandwidth to satisfy a performance demand for the message 220 transmitted using non-coherent peaky transmission. For example, the wireless communication device 205 may select the duty cycle θ (e.g., the duration Tₛ within each duty cycle period 255). As another example, the wireless communication device 205 may select the transmission bandwidth (e.g., how many subcarriers over which to transmit the message which may allow for more energy bearing tones 240 and thus fewer symbols). As another example, the wireless communication device may select the message length of the message 220 by increasing or decreasing the amount of redundancy (e.g., the amount of redundant bits for error checking purposes) and/or by adjusting CBGs of buffered data for transmission in the message 220. For example, the wireless communication device 205 may determine to transmit some of the data in a subsequent message 235 to keep the message 220 within a length that fits within a single duty cycle period 255.

In some examples, the wireless communication device 210 may transmit feedback 225 (e.g., HARQ feedback and/or power measurement information) for the message 220. In some examples, the wireless communication device 205 may select at least one of the duty cycle θ, the message length, or bandwidth for the subsequent message 235 based on the feedback 225 (e.g., based on the quantity of acknowledgments and/or negative acknowledgments).

In some examples, the message 220 may be a backscatter response to an interrogating signal 230. For example, peaky transmissions may be used by EH-capable devices to transmit backscatter responses to an interrogating signal from a reader device. In some examples, the message 220 may be an interrogating signal, and the wireless communication device 210 may be an EH-capable device which may transmit a backscatter response 265 to the interrogating signal.

As described herein, the message length and/or bandwidth for peaky transmissions may be determined (e.g., and/or adapted over time) based on key performance indicators (KPIs) such as delay constraints or error constraints. KPIs may be configured per message (e.g., based on the data within the messages). Messages involving multiple peaky symbols (e.g., peaky OFDM symbols) may have worse BLER and rate performance than messages with fewer peaky symbols as the probability of success in detecting the multiple peaky symbols correctly deteriorates as the quantity of peaky symbols forming the complete message increases. Thus, the transmitting wireless communication device (e.g., the wireless communication device 205) may adjust the message length to confine the respective transmission (e.g., the message 220) into a single peaky symbol when possible. The same goal of confining the respective transmission into a single peaky symbol may also be achieved by adjusting the transmission bandwidth (e.g., selecting a bandwidth based on the message length) if the selected bandwidth is available. In some examples, selection of the message length and/or bandwidth may be supported by power measurements and/or acknowledgment feedback mechanisms (e.g., ACK/NACK feedback such as the feedback 225) from the receiving device (e.g., the wireless communication device 210). In some examples, the duty cycle θ may be adjusted to meet the KPIs. For example, a duty cycle θ may be selected to be large enough to meet a delay constraint and/or small enough to improve error performance.

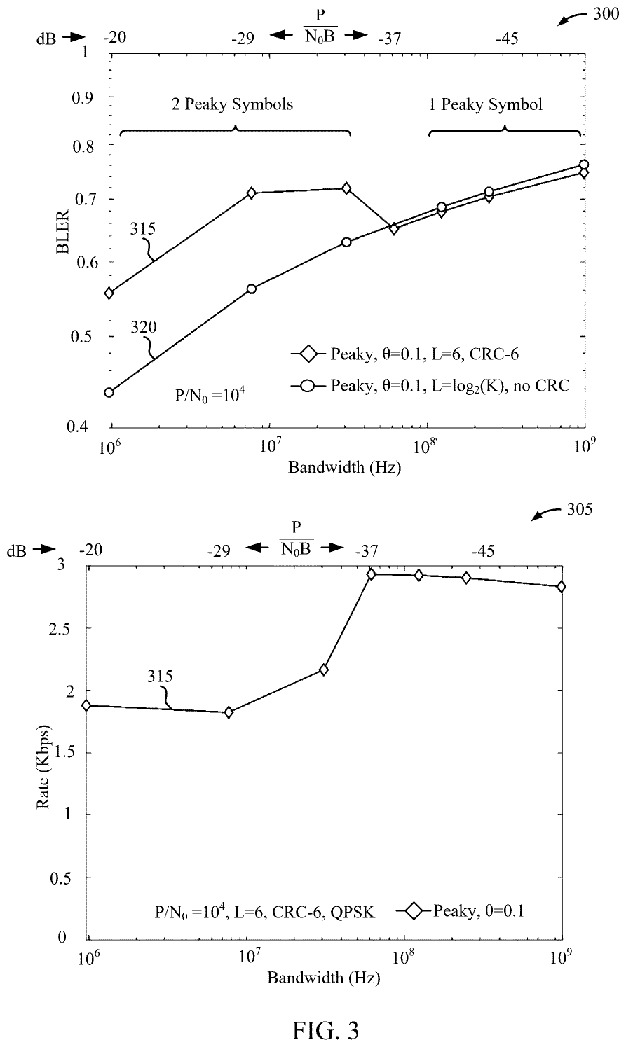

FIG. 3 shows an example of a graph 300 and a graph 305 that supports message adaptation over noncoherent channels in accordance with one or more aspects of the present disclosure. The graph 300 and the graph 305 may implement or may be implemented by aspects of the wireless communications system 100 or the wireless communications system 200.

In a peaky transmission, the maximum quantity of bits that a single peaky symbol can carry may be given by L′=log₂(B/Δf), where B is the bandwidth and Δf is the subcarrier spacing. Therefore, a message of L bits to be transmitted via peaky transmission demands at least N=┌L/L′┐ peaky symbols in order to transmit the message, where [ . . . ] is the ceiling operator.

The graph 300 shows a block error rate (BLER) of peaky transmissions at different transmission bandwidths given a subcarrier spacing of 15 kHz, a tapped delay line (TDL)-A channel with 100 nanoseconds of delay, no Doppler, P/N₀=10⁴, and minimum mean squared error reception. P may refer to the received power, and No may refer the noise spectral density. The graph 305 shows the rate in Kbps at different bandwidths at these conditions. The line 315 represents peaky transmissions having θ=0.1, a fixed message size of 6 bits for transmission (e.g., L=6), and a cyclic redundancy check (CRC) of 6 bits. The line 320 represents peaky transmissions having θ=0.1, a message size of log₂(K) for transmission, and no CRC, where K may be 2048 or 4096.

As shown in the graph 300, as the bandwidth increases for the fixed message size (e.g., the line 315), the BLER increases at the transition from two peaky symbols to one peaky symbol as each peaky symbol may add additional opportunity for error, and thus transmission over a single symbol may be associated with a lower BLER. For a fixed message size, the rate may also increase as shown in the graph 300 as the bandwidth increases, allowing transmission of the message over a single symbol as compared to two symbols.

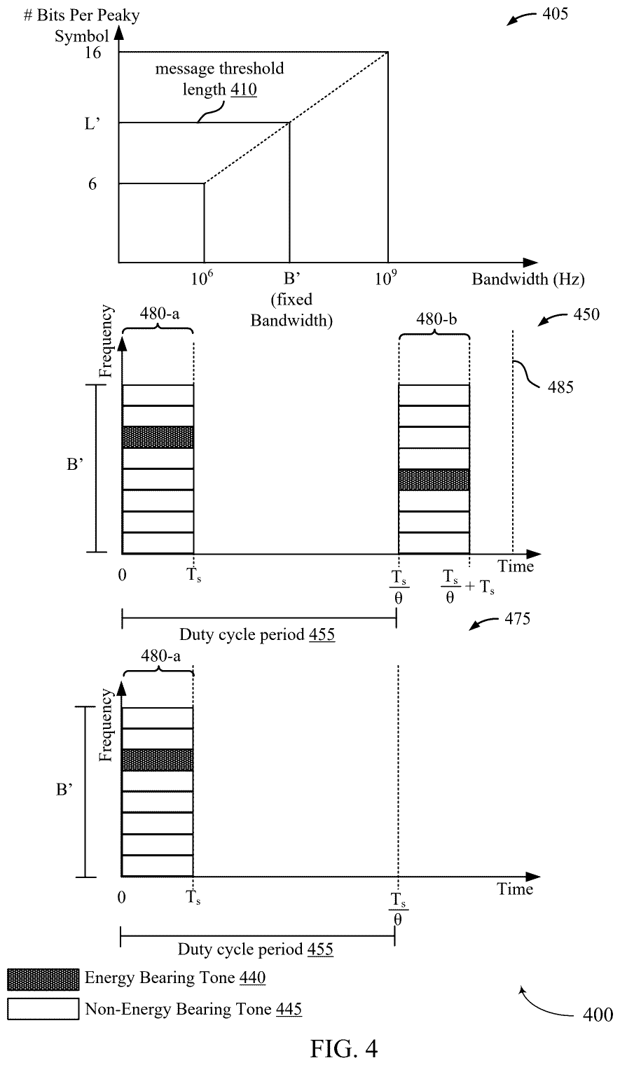

FIG. 4 shows an example of a message length adaptation scheme 400 that supports message adaptation over noncoherent channels in accordance with one or more aspects of the present disclosure. The message length adaptation scheme 400 may implement or may be implemented by aspects of the wireless communications system 100 or the wireless communications system 200.

As described herein, a wireless communication device 205 may transmit non-coherent messages (e.g., peaky transmissions) in accordance with a duty cycle θ. The transmitting wireless communication device (e.g., the wireless communication device 205) may adjust the message length to confine the respective transmission (e.g., the message 220) into a single peaky symbol when possible.

For example, as shown in the graph 405, for a fixed bandwidth B′, a message length threshold 410 may exist where messages having lengths (e.g., quantities of bits) greater than the message length threshold 410 are transmitted over two or more peaky symbols and thus two or more duty cycle periods 455 as shown in the resource diagram 450, and where messages having lengths less than or equal to the message length threshold 410 are transmitted over a single peaky symbol and thus one duty cycle period 455 as shown in the resource diagram 475.

Thus, if L<L′, where L is the quantity of bits to transmit in the message and L′ is the message length threshold 410, there is room to increase the message length until L=L′ and still transmit the message in a single peaky symbol without causing a significant impact on the error performance. Thus, when L<L′, the available additional bits may be used to convey more redundancy in the message and thus to improve error correction capability. As shown in the resource diagram 475, when L≤L′, a message may be transmitted in a single peaky symbol 480-a (e.g., in the energy bearing tones(s) 440 within the peaky symbol 480-a). The transmitting wireless communication device may refrain from transmitting in some tones (e.g., the non-energy bearing tones 445) of the single peaky symbol 480-a.

If L>L′, then the quantity of peaky symbols to transmit the message may be greater than or equal to 2, which may deteriorate the error performance under the fixed bandwidth B′. In such cases, in some examples, the transmitting wireless communication device may reduce the message length to confine the message to a single peaky symbol. Reducing the message length may be achieved by upper layer modifications, such as by changing CBGs and accompanying ACK/NACK mechanisms. As another example, the amount of redundancy may be reduced to achieve L≤L′. As shown in the resource diagram 450, when L>L′, a message may be transmitted in two or more peaky symbols (e.g., in the peaky symbol 480-a and the peaky symbol 480-b). In some examples, the message may be transmitted in the energy bearing tones(s) 440 within the two or more peaky symbols 480. The transmitting wireless communication device may refrain from transmitting in some tones (e.g., the non-energy bearing tones 445) of the two or more peaky symbols 480.

In some examples, the transmitting wireless communication device may select a smaller duty cycle to compensate for the deteriorating error performance. Selecting a smaller duty cycle may help for sufficiently large bandwidths, for example, which may be determined via a lookup table (e.g., to determine if the current bandwidth is sufficient for the desired duty cycle). A smaller duty cycle may impose a delay in receiving the last (e.g., the Nth) peaky symbol. Thus, the transmitting wireless communication device may determine whether to reduce the duty cycle based on a delay constraint associated with the message. For example, the transmitting wireless communication device may not reduce the duty cycle such that any portion of a message is transmitted after a delay constraint 485.

In some examples, mechanisms to adjust the message length and/or the duty cycle may be supported by power measurements and/or ACK/NACK mechanisms at the receiving wireless communication device to ensure a desired quality of service (QoS) level. In some examples, for a fixed bandwidth, if adjustments to the message length and/or the duty cycle are not able meet one or more KPIs, the transmitting wireless communication device may switch to a different transmission method (e.g., other than non-coherent transmission using peaky symbol transmission). For example, if power measurement feedback indicates received power of a message transmitted using peaky transmission is below a threshold, the transmitting wireless communication device may switch to a different transmission method. As another example, if a quantity of NACKs for CBGs within a message exceeds a threshold, the transmitting wireless communication device may switch to a different transmission method. In some examples, if duty cycle adjustment is unavailable due to the delay constraint 485, the transmitting wireless communication device may attempt to adjust the message length prior to switching to a different transmission method.

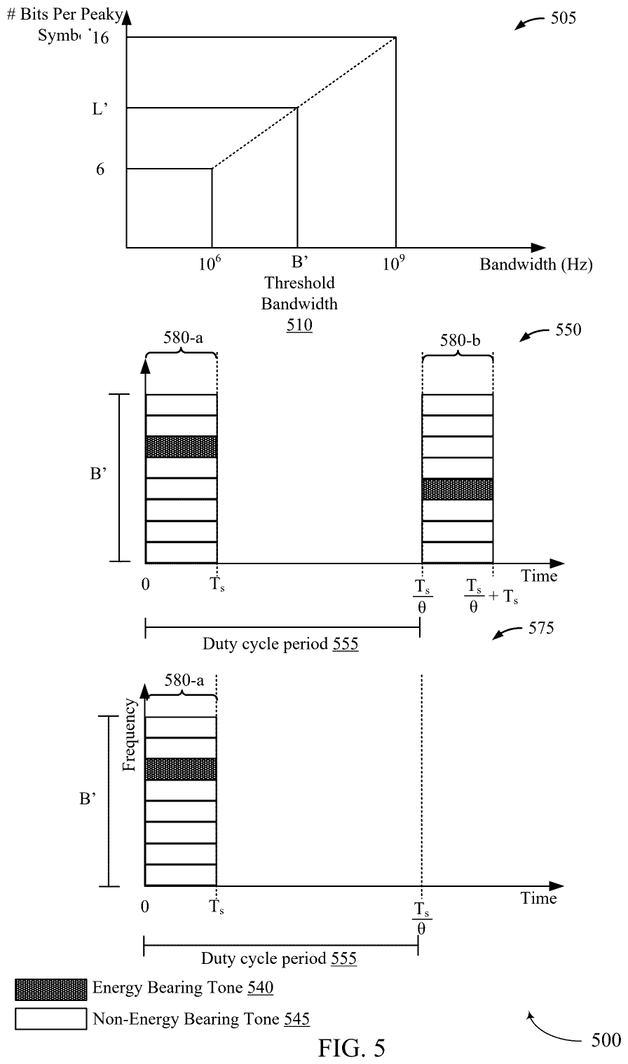

FIG. 5 shows an example of a bandwidth adaptation scheme 500 that supports message adaptation over noncoherent channels in accordance with one or more aspects of the present disclosure. The bandwidth adaptation scheme 500 may implement or may be implemented by aspects of the wireless communications system 100 or the wireless communications system 200.

As described herein, a wireless communication device 205 may transmit non-coherent messages (e.g., peaky transmissions) in accordance with a duty cycle θ. In some examples, the transmitting wireless communication device may adjust the transmission bandwidth to meet KPIs for the message. For example, to reduce error, the transmitting wireless communication device may select a bandwidth in order to confine the respective transmission (e.g., the message 220) into a single peaky symbol 580-a when possible.

For example, for a fixed message length as shown in the graph 505, a bandwidth threshold 510 may exist where if the available bandwidth is less than the bandwidth threshold 510, the message may be transmitted over two or more peaky symbols and thus two or more duty cycle periods 555 as shown in the resource diagram 550. Similarly, if the available bandwidth is greater than or equal to the bandwidth threshold 510, the message may be transmitted over a single peaky symbol 580-a and thus a single duty cycle period 555 as shown in the resource diagram 575. As shown in the resource diagram 550, when B<B′, a message may be transmitted in two or more peaky symbols (e.g., in the peaky symbol 580-a and the peaky symbol 580-b and in the energy bearing tones(s) 540 within the two or more peaky symbols). The transmitting wireless communication device may refrain from transmitting in some tones (e.g., the non-energy bearing tones 545) of the two or more peaky symbols. As shown in the resource diagram 575, when B≥B′ a message may be transmitted in a single peaky symbol 580-a (e.g., in the energy bearing tones(s) 540 within the peaky symbol). The transmitting wireless communication device may refrain from transmitting in some tones (e.g., the non-energy bearing tones 545) of the single peaky symbol 480-a.

Under the scenario where more frequency resources may be requested and/or allocated for a message, and where the message length is fixed, the bandwidth may accordingly be increased to confine the message to a single peaky symbol 580-a as shown in the resource diagram 575. For example, for a given subcarrier spacing Δf, a bandwidth B may be selected to satisfy L=log₂(B/Δf), where L is the fixed message length.

In some examples, the frequency resources may be limited such that B<Δf2^{L}. In such cases, messages may be transmitted over a small quantity of peaky symbols (e.g., and accordingly over a small quantity of duty cycle periods 555), which may have greater error performance than transmission over many peaky symbols.

Larger bandwidth may also resolve delay constraint issues with selection of a smaller duty cycle, and thus a larger bandwidth may allow for a smaller duty cycle to improve error performance. In some examples, the transmitting device may select a bandwidth from a range of available bandwidths based on a lookup table, for example, based on the message size, error constraints, and/or delay constraints.

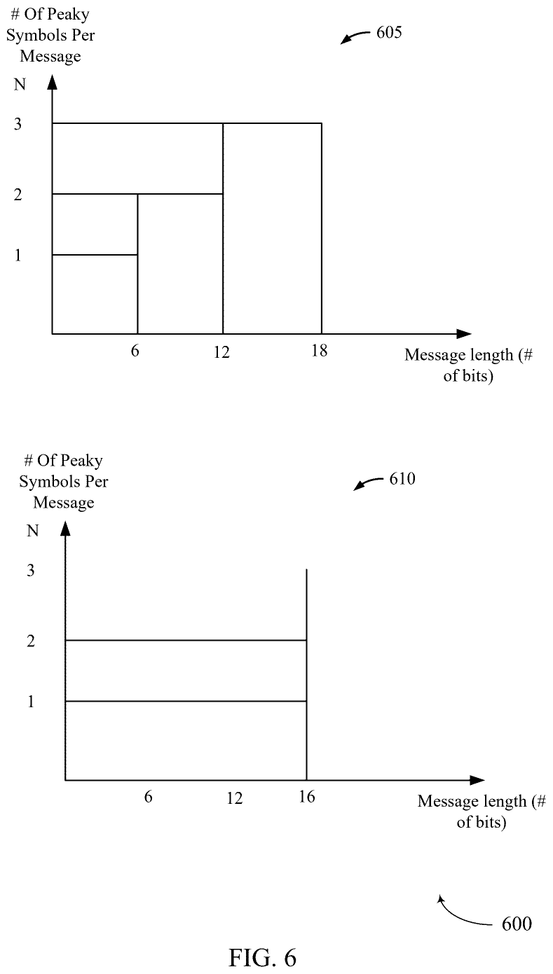

FIG. 6 shows an example of a bandwidth adaptation scheme 600 that supports message adaptation over noncoherent channels in accordance with one or more aspects of the present disclosure. The bandwidth adaptation scheme 600 may implement or may be implemented by aspects of the wireless communications system 100 or the wireless communications system 200.

As described herein, a wireless communication device 205 may transmit non-coherent messages (e.g., peaky transmissions) in accordance with a duty cycle θ. In some examples, the transmitting wireless communication device may adjust the transmission bandwidth to meet KPIs for the message. The graph 605 shows a quantity of peaky symbols to transmit a message at given message lengths in bits at a bandwidth of 1 MHz, and the graph 610 shows a quantity of peaky symbols to transmit a message at given message lengths in bits at a bandwidth of 1 GHz. As shown, more bits may be transmitted at the same quantity of peaky symbols using a higher bandwidth.

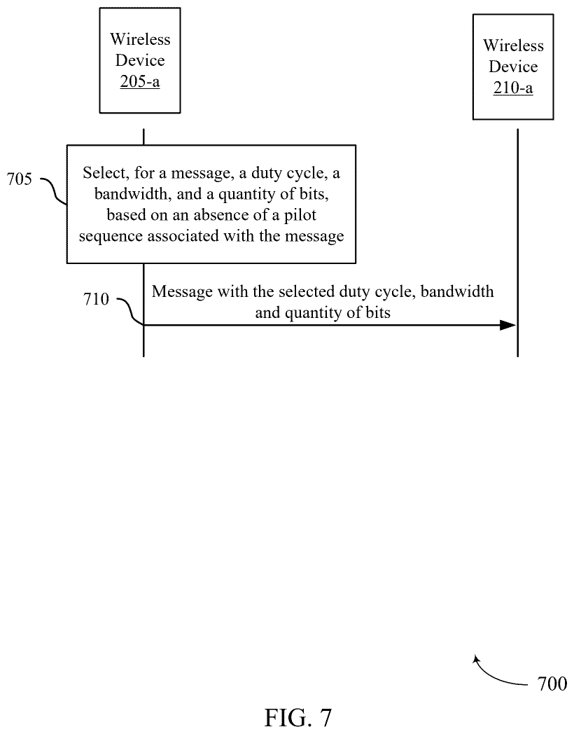

FIG. 7 shows an example of a process flow 700 that supports message adaptation over noncoherent channels in accordance with one or more aspects of the present disclosure. The process flow 700 may implement or may be implemented by aspects of the wireless communications system 100 or the wireless communications system 200. For example, the process flow may include a wireless communication device 205-a and a wireless communication device 210-a, which may be examples of a wireless communication device 205 and a wireless communication device 210 as described herein. In the following description of the process flow 700, the operations between the wireless communication device 205-a and the wireless communication device 210-a may be transmitted in a different order than the example order shown, or the operations performed by the wireless communication device 205-a and the wireless communication device 210-a may be performed in different orders or at different times. Some operations may also be omitted from the process flow 700, and other operations may be added to the process flow 700.

At 705, the wireless communication device 205-a may select, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message. For example, the message may be a non-coherent message as the message may not include a pilot sequence.

At 710, the wireless communication device 205-a may transmit, to the wireless communication device 210-a, the message including the quantity of bits during one or more symbols of a set of multiple symbols and via one or more frequency resources within the bandwidth. The wireless communication device 205-a may refrain from transmission during a remainder of the set of multiple symbols (e.g., may apply peaky transmission). The duty cycle may correspond to a ratio of the one or more symbols to a total quantity of symbols of the set of multiple symbols. The total quantity of symbols may include the one or more symbols and the remainder of the symbols.

In some examples, the wireless communication device 205-a may identify a set of data bits for transmission to the wireless communication device 210-a, and the at least one of the bandwidth, the duty cycle, or the quantity of bits may be selected by the wireless communication device 205-a to transmit the set of data bits within a single symbol based on the one or more performance demands.

In some examples, the wireless communication device 205-a may identify a set of data bits for transmission to the wireless communication device 210-a, the quantity of bits in the message may be selected based on the one or more performance demands associated with the message, and selecting the quantity of bits may involve selecting an amount of redundancy to include in the message for the quantity of bits.

In some examples, the wireless communication device 205-a may identify a set of data bits for transmission to the wireless communication device 210-a, where the quantity of bits in the message is selected based on the one or more performance demands associated with the message. In such examples, selecting the quantity of bits may involve selecting a subset of the set of data bits to include in the transmission. In some examples, the wireless communication device 205-a may transmit, to the wireless communication device 210-a and subsequent to transmission of the message at 710, a second message including a second subset of the set of data bits.

In some examples, the wireless communication device 205-a may select a larger duty cycle from a range of selectable duty cycles to satisfy a delay demand, the duty cycle may be selected based on the one or more performance demands, and the one or more performance demands may include the delay demand.

In some examples, the wireless communication device 205-a may select a larger bandwidth from within a range of selectable bandwidths to satisfy an error performance demand or a delay demand, the bandwidth may be selected based on the one or more performance demands, and the one or more performance demands may include the error performance demand or the delay demand.

In some examples, the wireless communication device 205-a may select, for a second message subsequent to the message, a second duty cycle, a second bandwidth, and a second quantity of bits to include in the second message, where at least one of the second bandwidth, the second duty cycle, or the second quantity of bits is selected based on one or more second performance demands associated with the second message and based on an absence of a pilot sequence associated with transmission of the second message, and where at least one of: the second duty cycle is different than the duty cycle; the second bandwidth is different than the bandwidth; or the second quantity of bits is different than the quantity of bits. In such examples, the wireless communication device 205-a may transmit, to the wireless communication device 210-a or a third wireless communication device, the second message including the second quantity of bits during one or more second symbols of a second set of multiple symbols and via one or more second frequency resources within the second bandwidth, where the wireless communication device 205-a refrains from transmission during a second remainder of the second set of multiple symbols, where the second duty cycle corresponds to a ratio of the one or more second symbols to a second total quantity of symbols of the second set of multiple symbols, the second total quantity of symbols including the one or more second symbols and the second remainder of the symbols. In some examples, the wireless communication device 205-a may receive feedback (e.g., power measurement feedback or ACK/NACK feedback) from the wireless communication device 210-a for the message at 710, and the at least one of the second bandwidth, the second duty cycle, or the second quantity of bits may be selected based on the feedback.

In some examples, the wireless communication device 205-a is a network entity 105, the wireless communication device 210-a is a UE 115, and the message at 710 is a downlink message.

In some examples, the wireless communication device 205-a is a UE 115, the wireless communication device 210-a is a network entity 105, and the message at 710 is an uplink message.

In some examples, the wireless communication device 205-a is a UE 115, the wireless communication device 210-a is a UE 115, and the message at 710 is a sidelink message.

In some examples, the message at 710 is an interrogating signal, and the wireless communication device 210-a is an EH-capable device. In such examples, the wireless communication device 210-a may transmit a backscatter response to the message, which may be received by the wireless communication device 205-a.

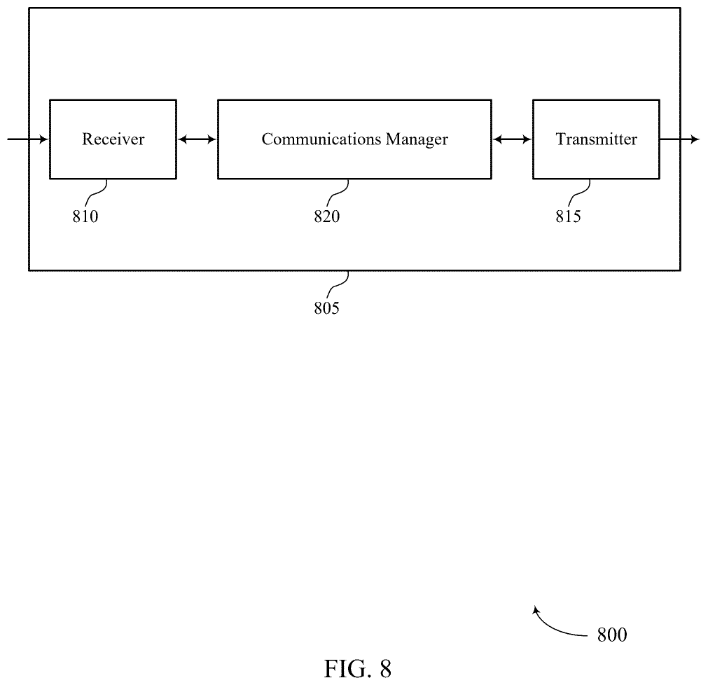

FIG. 8 shows a block diagram 800 of a device 805 that supports message adaptation over noncoherent channels in accordance with one or more aspects of the present disclosure. The device 805 may be an example of aspects of a UE 115 or a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to message adaptation over noncoherent channels). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to message adaptation over noncoherent channels). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of message adaptation over noncoherent channels as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message. The communications manager 820 is capable of, configured to, or operable to support a means for transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources.

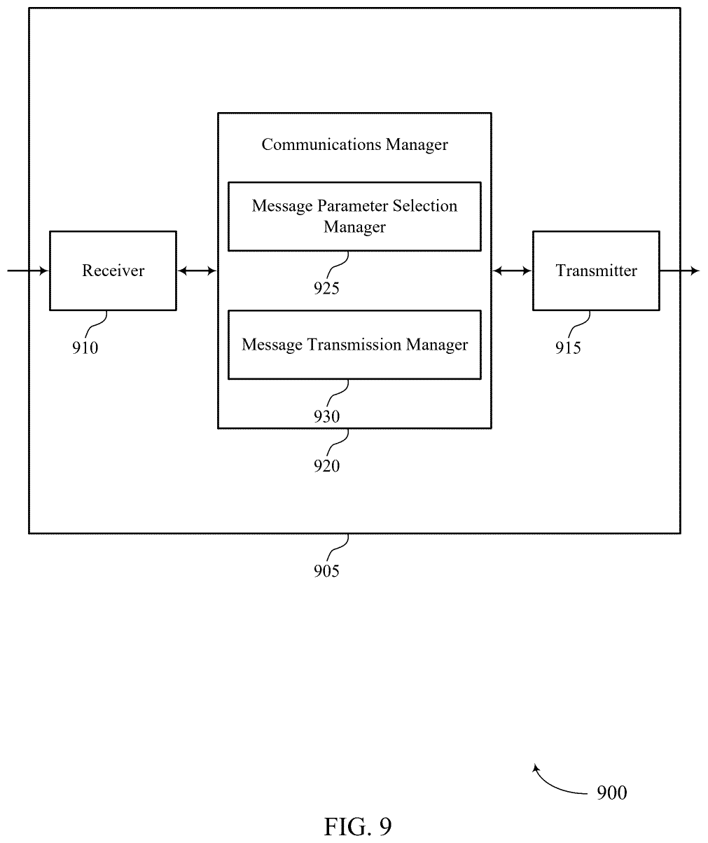

FIG. 9 shows a block diagram 900 of a device 905 that supports message adaptation over noncoherent channels in accordance with one or more aspects of the present disclosure. The device 905 may be an example of aspects of a device 805, a UE 115, or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to message adaptation over noncoherent channels). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to message adaptation over noncoherent channels). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of message adaptation over noncoherent channels as described herein. For example, the communications manager 920 may include a message parameter selection manager 925 a message transmission manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The message parameter selection manager 925 is capable of, configured to, or operable to support a means for selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message. The message transmission manager 930 is capable of, configured to, or operable to support a means for transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

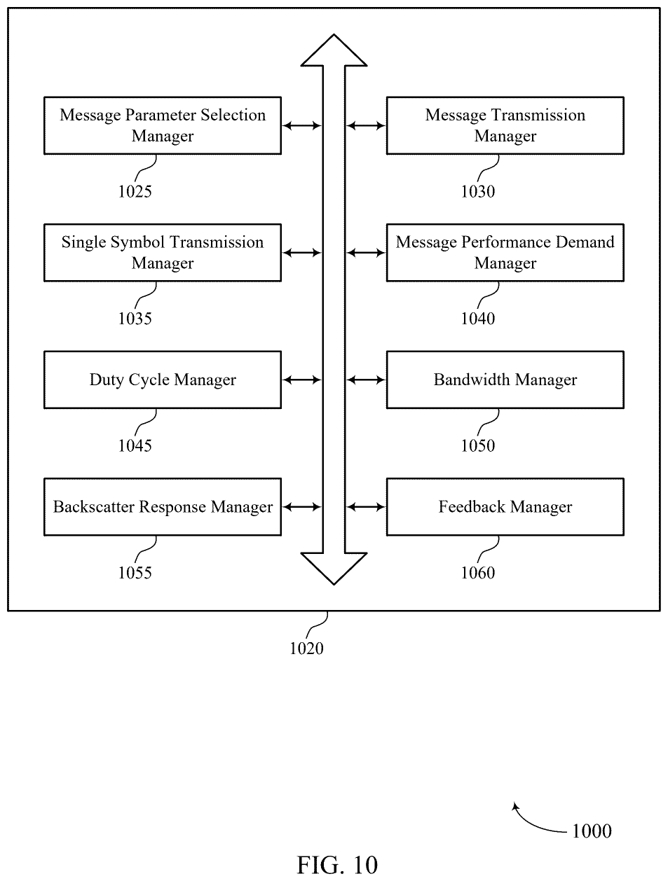

FIG. 10 shows a block diagram 1000 of a communications manager 1020 that supports message adaptation over noncoherent channels in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of message adaptation over noncoherent channels as described herein. For example, the communications manager 1020 may include a message parameter selection manager 1025, a message transmission manager 1030, a single symbol transmission manager 1035, a message performance demand manager 1040, a duty cycle manager 1045, a bandwidth manager 1050, a backscatter response manager 1055, a feedback manager 1060, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The message parameter selection manager 1025 is capable of, configured to, or operable to support a means for selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message. The message transmission manager 1030 is capable of, configured to, or operable to support a means for transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

In some examples, the single symbol transmission manager 1035 is capable of, configured to, or operable to support a means for identifying a set of data bits for transmission to the second wireless communication device, where the at least one of the bandwidth, the duty cycle, or the quantity of bits is selected to transmit the set of data bits within a single symbol based on the one or more performance demands.

In some examples, the message performance demand manager 1040 is capable of, configured to, or operable to support a means for identifying a set of data bits for transmission to the second wireless communication device, where the quantity of bits in the message is selected based on the one or more performance demands associated with the message, and where selecting the quantity of bits includes selecting an amount of redundancy to include in the message for the quantity of bits.

In some examples, the message performance demand manager 1040 is capable of, configured to, or operable to support a means for identifying a set of data bits for transmission to the second wireless communication device, where the quantity of bits in the message is selected based on the one or more performance demands associated with the message, and where selecting the quantity of bits includes selecting a subset of the set of data bits to include in the transmission.

In some examples, the message transmission manager 1030 is capable of, configured to, or operable to support a means for transmitting, to the second wireless communication device and subsequent to transmission of the message, a second message including a second subset of the set of data bits.

In some examples, the duty cycle manager 1045 is capable of, configured to, or operable to support a means for selecting a smaller duty cycle from a range of selectable duty cycles to satisfy an error performance demand, where the duty cycle is selected based on the one or more performance demands, and where the one or more performance demands include the error performance demand.

In some examples, the duty cycle manager 1045 is capable of, configured to, or operable to support a means for selecting a larger duty cycle from a range of selectable duty cycles to satisfy a delay demand, where the duty cycle is selected based on the one or more performance demands, and where the one or more performance demands include the delay demand.

In some examples, to support selecting the duty cycle, the bandwidth, and the quantity, the bandwidth manager 1050 is capable of, configured to, or operable to support a means for selecting a larger bandwidth from within a range of selectable bandwidths to satisfy an error performance demand or a delay demand, where the bandwidth is selected based on the one or more performance demands, and where the one or more performance demands include the error performance demand or the delay demand.

In some examples, the duty cycle manager 1045 is capable of, configured to, or operable to support a means for selecting, for a second message subsequent to the message, a second duty cycle, a second bandwidth, and a second quantity of bits to include in the second message, where at least one of the second bandwidth, the second duty cycle, or the second quantity of bits is selected based on one or more second performance demands associated with the second message and based on an absence of a pilot sequence associated with transmission of the second message, and where at least one of the second duty cycle is different than the duty cycle, the second bandwidth is different than the bandwidth, or the second quantity of bits is different than the quantity of bits. In some examples, the message transmission manager 1030 is capable of, configured to, or operable to support a means for transmitting, to the second wireless communication device or a third wireless communication device, the second message including the second quantity of bits during one or more second symbols of a second set of multiple symbols and via one or more second frequency resources within the second bandwidth, where the first wireless communication device refrains from transmission during a second remainder of the second set of multiple symbols, where the second duty cycle corresponds to a ratio of the one or more second symbols to a second total quantity of symbols of the second set of multiple symbols, the second total quantity of symbols including the one or more second symbols and the second remainder of the symbols.

In some examples, the feedback manager 1060 is capable of, configured to, or operable to support a means for receiving a feedback from the second wireless communication device for the message, where the at least one of the second bandwidth, the second duty cycle, or the second quantity of bits is selected based on the feedback.

In some examples, to support transmitting the message, the message transmission manager 1030 is capable of, configured to, or operable to support a means for transmitting the message to a UE, where the second wireless communication device is the UE, and where the first wireless communication device is a network entity.

In some examples, to support transmitting the message, the message transmission manager 1030 is capable of, configured to, or operable to support a means for transmitting the message to a network entity, where the second wireless communication device is the network entity, and where the first wireless communication device is a user equipment.

In some examples, the message transmission manager 1030 is capable of, configured to, or operable to support a means for transmitting the message to a first UE, where the second wireless communication device is the first UE, and where the first wireless communication device is a second UE.

In some examples, the message transmission manager 1030 is capable of, configured to, or operable to support a means for transmitting the message to an energy harvesting (EH)-capable device. In some examples, the backscatter response manager 1055 is capable of, configured to, or operable to support a means for receiving, from the EH-capable device, a backscatter response to the message.

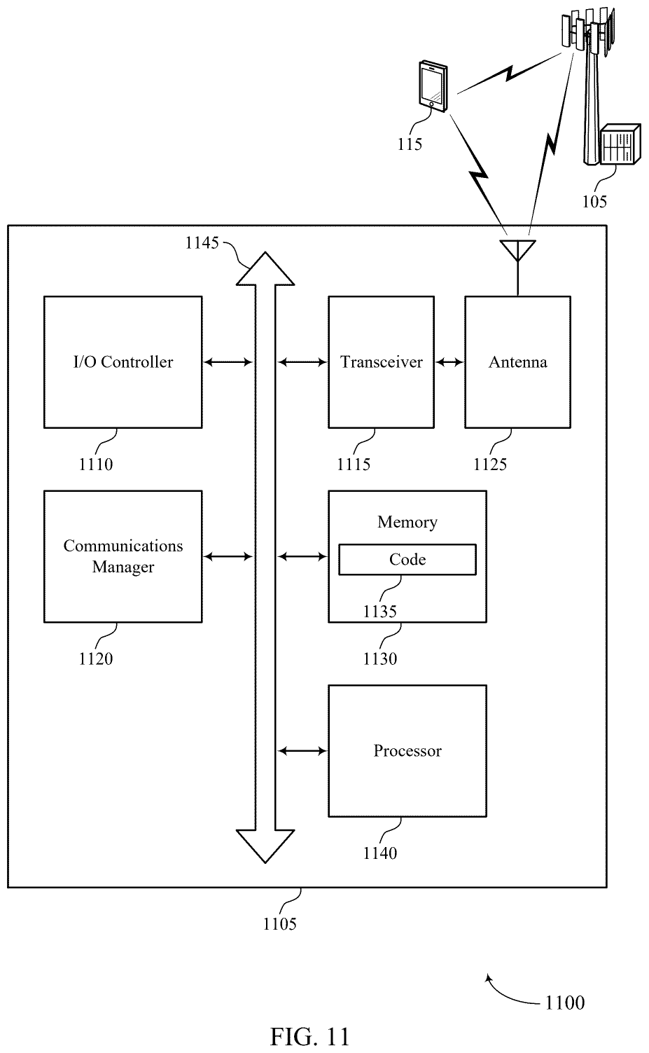

FIG. 11 shows a diagram of a system 1100 including a device 1105 that supports message adaptation over noncoherent channels in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting message adaptation over noncoherent channels). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message. The communications manager 1120 is capable of, configured to, or operable to support a means for transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

By including or configuring the communications manager 1120 in accordance with examples as described herein, the device 1105 may support techniques for improved communication reliability, reduced latency, reduced power consumption, more efficient utilization of communication resources, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of message adaptation over noncoherent channels as described herein, or the at least one processor 1140 and the at least one memory 1130 may be otherwise configured to, individually or collectively, perform or support such operations.

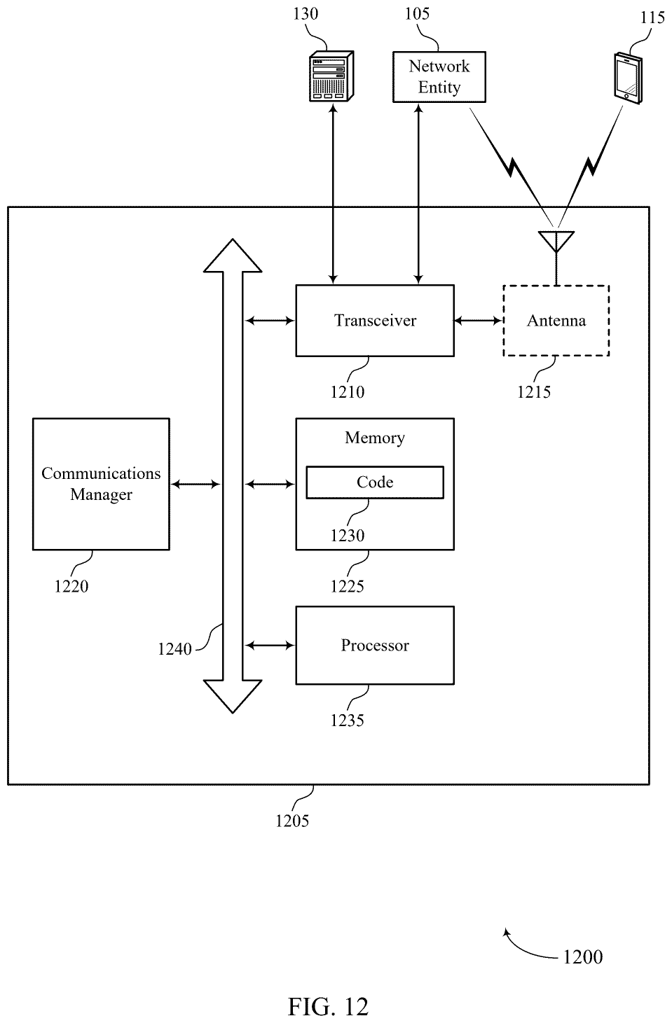

FIG. 12 shows a diagram of a system 1200 including a device 1205 that

supports message adaptation over noncoherent channels in accordance with one or more aspects of the present disclosure. The device 1205 may be an example of or include components of a device 805, a device 905, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting message adaptation over noncoherent channels). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message. The communications manager 1220 is capable of, configured to, or operable to support a means for transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols.

By including or configuring the communications manager 1220 in accordance with examples as described herein, the device 1205 may support techniques for improved communication reliability, reduced latency, reduced power consumption, more efficient utilization of communication resources, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of message adaptation over noncoherent channels as described herein, or the at least one processor 1235 and the at least one memory 1225 may be otherwise configured to, individually or collectively, perform or support such operations.

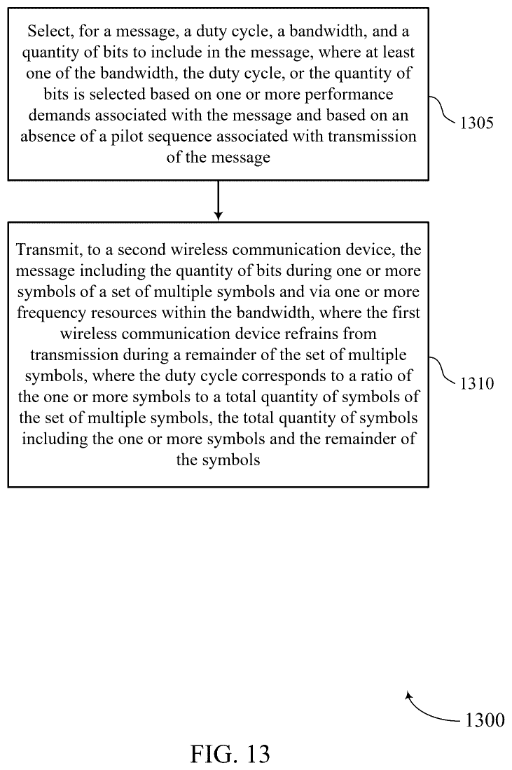

FIG. 13 shows a flowchart illustrating a method 1300 that supports message adaptation over noncoherent channels in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include selecting, for a message, a duty cycle, a bandwidth, and a quantity of bits to include in the message, where at least one of the bandwidth, the duty cycle, or the quantity of bits is selected based on one or more performance demands associated with the message and based on an absence of a pilot sequence associated with transmission of the message. The operations of 1305 may be performed in accordance with examples as disclosed herein. In some examples, aspects of the operations of 1305 may be performed by a message parameter selection manager 1025 as described with reference to FIG. 10.

At 1310, the method may include transmitting, to a second wireless communication device, the message including the quantity of bits during one or more symbols of a set of multiple symbols and via one or more frequency resources within the bandwidth, where the first wireless communication device refrains from transmission during a remainder of the set of multiple symbols, where the duty cycle corresponds to a ratio of the one or more symbols to a total quantity of symbols of the set of multiple symbols, the total quantity of symbols including the one or more symbols and the remainder of the symbols. The operations of 1310 may be performed in accordance with examples as disclosed herein. In some examples, aspects of the operations of 1310 may be performed by a message transmission manager 1030 as described with reference to FIG. 10.

The following provides an overview of aspects of the present disclosure:

Aspect 1: A method for wireless communications at a first wireless communication device, comprising: selecting, for a message, a duty cycle, a bandwidth, and a quantity of bits to include in the message, wherein at least one of the bandwidth, the duty cycle, or the quantity of bits is selected based at least in part on one or more performance demands associated with the message and based at least in part on an absence of a pilot sequence associated with transmission of the message; and transmitting, to a second wireless communication device, the message comprising the quantity of bits during one or more symbols of a plurality of symbols and via one or more frequency resources within the bandwidth, wherein the first wireless communication device refrains from transmission during a remainder of the plurality of symbols, wherein the duty cycle corresponds to a ratio of the one or more symbols to a total quantity of symbols of the plurality of symbols, the total quantity of symbols comprising the one or more symbols and the remainder of the symbols.

Aspect 2: The method of aspect 1, further comprising: identifying a set of data bits for transmission to the second wireless communication device, wherein the at least one of the bandwidth, the duty cycle, or the quantity of bits is selected to transmit the set of data bits within a single symbol based at least in part on the one or more performance demands.

Aspect 3: The method of any of aspects 1 through 2, further comprising: identifying a set of data bits for transmission to the second wireless communication device, wherein the quantity of bits in the message is selected based at least in part on the one or more performance demands associated with the message, and wherein selecting the quantity of bits comprises selecting an amount of redundancy to include in the message for the quantity of bits.

Aspect 4: The method of any of aspects 1 through 3, further comprising: identifying a set of data bits for transmission to the second wireless communication device, wherein the quantity of bits in the message is selected based at least in part on the one or more performance demands associated with the message, and wherein selecting the quantity of bits comprises selecting a subset of the set of data bits to include in the transmission.

Aspect 5: The method of aspect 4, further comprising: transmitting, to the second wireless communication device and subsequent to transmission of the message, a second message comprising a second subset of the set of data bits.

Aspect 6: The method of any of aspects 1 through 5, further comprising: selecting a smaller duty cycle from a range of selectable duty cycles to satisfy an error performance demand, wherein the duty cycle is selected based at least in part on the one or more performance demands, and wherein the one or more performance demands comprise the error performance demand.

Aspect 7: The method of any of aspects 1 through 5, further comprising: selecting a larger duty cycle from a range of selectable duty cycles to satisfy a delay demand, wherein the duty cycle is selected based at least in part on the one or more performance demands, and wherein the one or more performance demands comprise the delay demand.

Aspect 8: The method of any of aspects 1 through 7, wherein selecting the duty cycle, the bandwidth, and the quantity comprises: selecting a larger bandwidth from within a range of selectable bandwidths to satisfy an error performance demand or a delay demand, wherein the bandwidth is selected based at least in part on the one or more performance demands, and wherein the one or more performance demands comprise the error performance demand or the delay demand.

Aspect 9: The method of any of aspects 1 through 8, further comprising: selecting, for a second message subsequent to the message, a second duty cycle, a second bandwidth, and a second quantity of bits to include in the second message, wherein at least one of the second bandwidth, the second duty cycle, or the second quantity of bits is selected based at least in part on one or more second performance demands associated with the second message and based at least in part on an absence of a pilot sequence associated with transmission of the second message, and wherein at least one of the second duty cycle is different than the duty cycle, the second bandwidth is different than the bandwidth, or the second quantity of bits is different than the quantity of bits; and transmitting, to the second wireless communication device or a third wireless communication device, the second message comprising the second quantity of bits during one or more second symbols of a second plurality of symbols and via one or more second frequency resources within the second bandwidth, wherein the first wireless communication device refrains from transmission during a second remainder of the second plurality of symbols, wherein the second duty cycle corresponds to a ratio of the one or more second symbols to a second total quantity of symbols of the second plurality of symbols, the second total quantity of symbols comprising the one or more second symbols and the second remainder of the symbols.

Aspect 10: The method of aspect 9, further comprising: receiving a feedback from the second wireless communication device for the message, wherein the at least one of the second bandwidth, the second duty cycle, or the second quantity of bits is selected based at least in part on the feedback.

Aspect 11: The method of any of aspects 1 through 10, wherein transmitting the message comprises: transmitting the message to a UE, wherein the second wireless communication device is the UE, and wherein the first wireless communication device is a network entity.

Aspect 12: The method of any of aspects 1 through 10, wherein transmitting the message comprises: transmitting the message to a network entity, wherein the second wireless communication device is the network entity, and wherein the first wireless communication device is a UE.

Aspect 13: The method of any of aspects 1 through 10, further comprising: transmitting the message to a first UE, wherein the second wireless communication device is the first UE, and wherein the first wireless communication device is a second UE.

Aspect 14: The method of any of aspects 1 through 10, further comprising: transmitting the message to an EH-capable device; and receiving, from the EH-capable device, a backscatter response to the message.

Aspect 15: A first wireless communication device for wireless communications, comprising one or more memories storing processor-executable code, and one or more processors coupled with the one or more memories and individually or collectively operable to execute the code to cause the first wireless communication device to perform a method of any of aspects 1 through 14.

Aspect 16: A first wireless communication device for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless communication device, comprising:
one or more memories storing processor-executable code; and
one or more processors coupled with the one or more memories and individually or collectively operable to execute the code to cause the first wireless communication device to:
select, for a message, a duty cycle, a bandwidth, and a quantity of bits to include in the message, wherein at least one of the bandwidth, the duty cycle, or the quantity of bits is selected based at least in part on one or more performance demands associated with the message and based at least in part on an absence of a pilot sequence associated with transmission of the message; and
transmit, to a second wireless communication device, the message comprising the quantity of bits during one or more symbols of a plurality of symbols and via one or more frequency resources within the bandwidth, wherein the first wireless communication device refrains from transmission during a remainder of the plurality of symbols, wherein the duty cycle corresponds to a ratio of the one or more symbols to a total quantity of symbols of the plurality of symbols, the total quantity of symbols comprising the one or more symbols and the remainder of the symbols.

2. The first wireless communication device of claim 1, wherein the one or more processors are individually or collectively further operable to execute the code to cause the first wireless communication device to:
identify a set of data bits for transmission to the second wireless communication device, wherein the at least one of the bandwidth, the duty cycle, or the quantity of bits is selected to transmit the set of data bits within a single symbol based at least in part on the one or more performance demands.

3. The first wireless communication device of claim 1, wherein the one or more processors are individually or collectively further operable to execute the code to cause the first wireless communication device to:
identify a set of data bits for transmission to the second wireless communication device, wherein the quantity of bits in the message is selected based at least in part on the one or more performance demands associated with the message, and wherein selecting the quantity of bits comprises selecting an amount of redundancy to include in the message for the quantity of bits.

4. The first wireless communication device of claim 1, wherein the one or more processors are individually or collectively further operable to execute the code to cause the first wireless communication device to:
identify a set of data bits for transmission to the second wireless communication device, wherein the quantity of bits in the message is selected based at least in part on the one or more performance demands associated with the message, and wherein selecting the quantity of bits comprises selecting a subset of the set of data bits to include in the transmission.

5. The first wireless communication device of claim 4, wherein the one or more processors are individually or collectively further operable to execute the code to cause the first wireless communication device to:
transmit, to the second wireless communication device and subsequent to transmission of the message, a second message comprising a second subset of the set of data bits.

6. The first wireless communication device of claim 1, wherein the one or more processors are individually or collectively further operable to execute the code to cause the first wireless communication device to:
select a smaller duty cycle from a range of selectable duty cycles to satisfy an error performance demand, wherein the duty cycle is selected based at least in part on the one or more performance demands, and wherein the one or more performance demands comprise the error performance demand.

7. The first wireless communication device of claim 1, wherein the one or more processors are individually or collectively further operable to execute the code to cause the first wireless communication device to:
select a larger duty cycle from a range of selectable duty cycles to satisfy a delay demand, wherein the duty cycle is selected based at least in part on the one or more performance demands, and wherein the one or more performance demands comprise the delay demand.

8. The first wireless communication device of claim 1, wherein, to select the duty cycle, the bandwidth, and the quantity, the one or more processors are individually or collectively operable to execute the code to cause the first wireless communication device to:
select a larger bandwidth from within a range of selectable bandwidths to satisfy an error performance demand or a delay demand, wherein the bandwidth is selected based at least in part on the one or more performance demands, and wherein the one or more performance demands comprise the error performance demand or the delay demand.

9. The first wireless communication device of claim 1, wherein the one or more processors are individually or collectively further operable to execute the code to cause the first wireless communication device to:
select, for a second message subsequent to the message, a second duty cycle, a second bandwidth, and a second quantity of bits to include in the second message, wherein at least one of the second bandwidth, the second duty cycle, or the second quantity of bits is selected based at least in part on one or more second performance demands associated with the second message and based at least in part on an absence of a pilot sequence associated with transmission of the second message, and wherein at least one of the second duty cycle is different than the duty cycle, the second bandwidth is different than the bandwidth, or the second quantity of bits is different than the quantity of bits; and
transmit, to the second wireless communication device or a third wireless communication device, the second message comprising the second quantity of bits during one or more second symbols of a second plurality of symbols and via one or more second frequency resources within the second bandwidth, wherein the first wireless communication device refrains from transmission during a second remainder of the second plurality of symbols, wherein the second duty cycle corresponds to a ratio of the one or more second symbols to a second total quantity of symbols of the second plurality of symbols, the second total quantity of symbols comprising the one or more second symbols and the second remainder of the symbols.

10. The first wireless communication device of claim 9, wherein the one or more processors are individually or collectively further operable to execute the code to cause the first wireless communication device to:
receive a feedback from the second wireless communication device for the message, wherein the at least one of the second bandwidth, the second duty cycle, or the second quantity of bits is selected based at least in part on the feedback.

11. The first wireless communication device of claim 1, wherein, to transmit the message, the one or more processors are individually or collectively operable to execute the code to cause the first wireless communication device to:
transmit the message to a user equipment (UE), wherein the second wireless communication device is the UE, and wherein the first wireless communication device is a network entity.

12. The first wireless communication device of claim 1, wherein, to transmit the message, the one or more processors are individually or collectively operable to execute the code to cause the first wireless communication device to:
transmit the message to a network entity, wherein the second wireless communication device is the network entity, and wherein the first wireless communication device is a user equipment.

13. The first wireless communication device of claim 1, wherein the one or more processors are individually or collectively further operable to execute the code to cause the first wireless communication device to:
transmit the message to a first user equipment (UE), wherein the second wireless communication device is the first UE, and wherein the first wireless communication device is a second UE.

14. The first wireless communication device of claim 1, wherein the one or more processors are individually or collectively further operable to execute the code to cause the first wireless communication device to:
transmit the message to an energy harvesting (EH)-capable device; and
receive, from the EH-capable device, a backscatter response to the message.

15. A method for wireless communications at a first wireless communication device, comprising:
selecting, for a message, a duty cycle, a bandwidth, and a quantity of bits to include in the message, wherein at least one of the bandwidth, the duty cycle, or the quantity of bits is selected based at least in part on one or more performance demands associated with the message and based at least in part on an absence of a pilot sequence associated with transmission of the message; and
transmitting, to a second wireless communication device, the message comprising the quantity of bits during one or more symbols of a plurality of symbols and via one or more frequency resources within the bandwidth, wherein the first wireless communication device refrains from transmission during a remainder of the plurality of symbols, wherein the duty cycle corresponds to a ratio of the one or more symbols to a total quantity of symbols of the plurality of symbols, the total quantity of symbols comprising the one or more symbols and the remainder of the symbols.

16. The method of claim 15, further comprising:
identifying a set of data bits for transmission to the second wireless communication device, wherein the at least one of the bandwidth, the duty cycle, or the quantity of bits is selected to transmit the set of data bits within a single symbol based at least in part on the one or more performance demands.

17. The method of claim 15, further comprising:
identifying a set of data bits for transmission to the second wireless communication device, wherein the quantity of bits in the message is selected based at least in part on the one or more performance demands associated with the message, and wherein selecting the quantity of bits comprises selecting an amount of redundancy to include in the message for the quantity of bits.

18. The method of claim 15, further comprising:
identifying a set of data bits for transmission to the second wireless communication device, wherein the quantity of bits in the message is selected based at least in part on the one or more performance demands associated with the message, and wherein selecting the quantity of bits comprises selecting a subset of the set of data bits to include in the transmission.

19. The method of claim 18, further comprising:
transmitting, to the second wireless communication device and subsequent to transmission of the message, a second message comprising a second subset of the set of data bits.

20. A non-transitory computer-readable medium storing code for wireless communications by a first wireless communication device, the code comprising instructions executable by one or more processors to:
select, for a message, a duty cycle, a bandwidth, and a quantity of bits to include in the message, wherein at least one of the bandwidth, the duty cycle, or the quantity of bits is selected based at least in part on one or more performance demands associated with the message and based at least in part on an absence of a pilot sequence associated with transmission of the message; and
transmit, to a second wireless communication device, the message comprising the quantity of bits during one or more symbols of a plurality of symbols and via one or more frequency resources within the bandwidth, wherein the first wireless communication device refrains from transmission during a remainder of the plurality of symbols, wherein the duty cycle corresponds to a ratio of the one or more symbols to a total quantity of symbols of the plurality of symbols, the total quantity of symbols comprising the one or more symbols and the remainder of the symbols.
